(19) United States
(12) Patent Application Publication
(10) Pub. No.: US 2026/0075360 A1
(43) Pub. Date: Mar. 12, 2026

(54) ELECTRONIC DEVICE FOR PERFORMING OPERATION ACCORDING TO MOISTURE DETECTION, OPERATION METHOD THEREOF, AND STORAGE MEDIUM

(71) Applicant: Samsung Electronics Co., Ltd., Suwon-si (KR)

(72) Inventors: Chaehoon LIM, Suwon-si (KR); Kyoungup KIM, Suwon-si (KR); Minseok KIM, Suwon-si (KR); Minsu RHEE, Suwon-si (KR)

(21) Appl. No.: 19/388,312

(22) Filed: Nov. 13, 2025

Related U.S. Application Data
(63) Continuation of application No. PCT/KR2024/004747, filed on Apr. 9, 2024.

(30) Foreign Application Priority Data
Jun. 9, 2023 (KR) 10-2023-0074026
May 18, 2023 (KR) 10-2023-0064157

(51) Int. Cl. H04R 1/44; H04R 29/00

(52) U.S. Cl. CPC H04R 1/44; H04R 29/00

(57) ABSTRACT

An electronic device is provided. The electronic device includes speakers, memory, including one or more storage media, storing instructions, and one or more processors communicatively coupled to the multiple speakers and the memory, wherein the instructions, when executed by the one or more processors individually or collectively, cause the electronic device to in response to execution of a designated function, identify moisture introduction into at least one speaker among the multiple speakers by using the multiple speakers, output information for guiding a tilting direction of the electronic device to discharge the moisture introduced into the at least one speaker, and cause the at least one speaker to perform a moisture discharge function.

### CROSS-REFERENCE TO RELATED APPLICATIONS

This application is a continuation application, claiming priority under 35 U.S.C. § 365(c), of an International application No. PCT/KR2024/004747, filed on April 9, 2024, which is based on and claims the benefit of a Korean patent application number 10-2023-0064157, filed on May 18, 2023, in the Korean Intellectual Property Office, and of a Korean patent application number 10-2023-0074026, filed on June 9, 2023, in the Korean Intellectual Property Office, the disclosure of each of which is incorporated by reference herein in its entirety.

### BACKGROUND

### 1. Field

The disclosure relates to an electronic device for performing an operation according to moisture detection, an operating method, and a storage medium.

### 2. Description of Related Art

The increasing in the variety of services and additional functions provided through electronic devices such as smartphones gradually induces development of various applications that may be executed on electronic devices. In addition, the development in the hardware and/or software parts of electronic devices is also continuing to progress.

For example, an electronic device may include a speaker configured to output a sound included in a content to the outside. The electronic device may include one speaker, and may include multiple speakers configured to provide a sound in various functions or formats. For example, the electronic device may include a separate speaker configured to perform a specific function (e.g., a call function) or may include multiple speakers that configure multiple channels (e.g., 2.1 channels).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for performing an operation according to moisture detection, an operating method, and a storage medium.

Additional aspects will be set forth in part in the description which follows and, in part, will be apparent from the description, or may be learned by practice of the presented embodiments.

In accordance with an aspect of the disclosure, an electronic device is provided. The electronic device includes multiple speakers, memory, including one or more storage media, storing instructions, and one or more processors communicatively coupled to the multiple speakers and the memory, wherein the instructions, when executed by the one or more processors individually or collectively, cause the electronic device to in response to execution of a designated function, identify moisture introduction into at least one speaker among the multiple speakers by using the multiple speakers, output information for guiding a tilting direction of the electronic device to discharge the moisture introduced into the at least one speaker, and cause the at least one speaker to perform a moisture discharge function.

In accordance with another aspect of the disclosure, a method performed by an electronic device for performing an operation according to detection of moisture introduction in the electronic device is provided. The method includes in response to execution of a designated function, identifying, by the electronic device, moisture introduction into at least one speaker among multiple speakers by using the multiple speakers, outputting, by the electronic device, information for guiding a tilting direction of the electronic device to discharge moisture introduced into the at least one speaker, and causing, by the electronic device, the at least one speaker to perform a moisture discharge function.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include in response to execution of a designated function, identifying, by the electronic device, moisture introduction into at least one speaker among multiple speakers by using the multiple speakers, outputting, by the electronic device, information for guiding a tilting direction of the electronic device to discharge moisture that has been introduced into the at least one speaker, and causing, by the electronic device, the at least one speaker to perform a moisture discharge function. The at least one operation includes an operation of enabling the at least one speaker to perform a moisture discharge function.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating an example of an electronic device of a first type according to an embodiment of the disclosure;

FIG. 3A is a diagram illustrating an example of an electronic device of a second type in a first state according to an embodiment of the disclosure;

FIG. 3B is a diagram illustrating an example of an electronic device of a second type in a second state according to an embodiment of the disclosure;

FIG. 4 is a diagram illustrating a moisture introduction situation according to an embodiment of the disclosure;

FIG. 5A is an internal block diagram of an electronic device according to an embodiment of the disclosure;

FIG. 5B is a block diagram of a periphery of a speaker according to an embodiment of the disclosure;

FIG. 6 is a diagram illustrating an example of an electronic device for detecting moisture introduction according to an embodiment of the disclosure;

FIG. 7 is a flowchart of operations of an electronic device for performing an operation according to moisture detection according to an embodiment of the disclosure;

FIG. 8 is a flowchart of operations in an electronic device according to moisture detection using a connection terminal and a reference sound according to an embodiment of the disclosure;

FIG. 9 is a flowchart of operations in an electronic device according to moisture detection using a connection terminal and a designated terminal of a speaker according to an embodiment of the disclosure;

FIG. 10 is a flowchart of operations in an electronic device according to moisture detection using at least one of a reference sound or a designated terminal of a speaker according to an embodiment of the disclosure; and

FIG. 11 is a diagram of a screen for guiding an operation for moisture removal according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

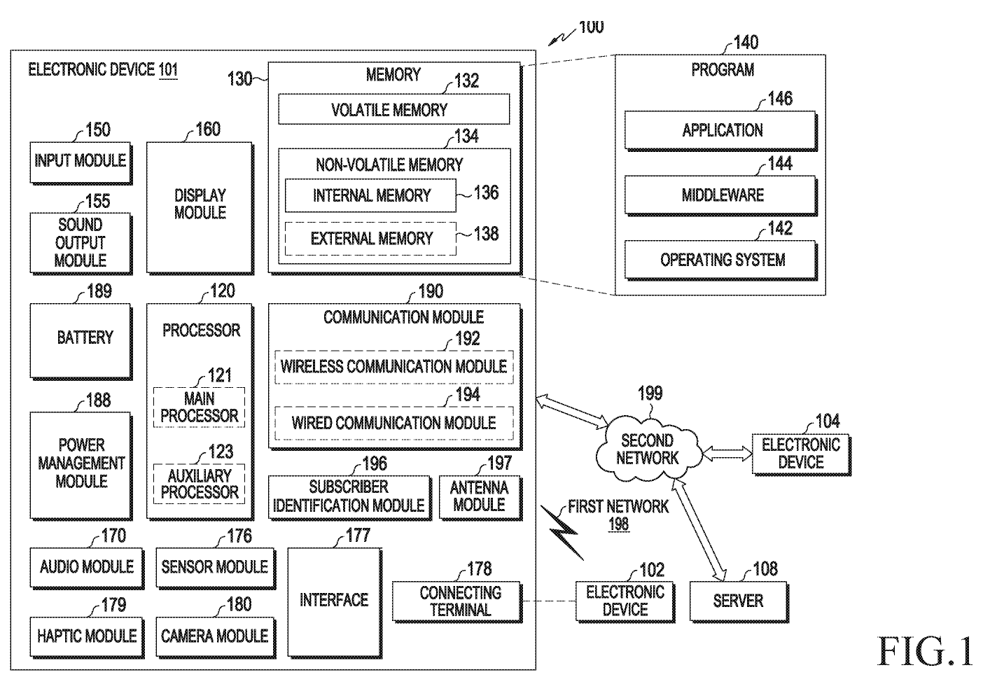

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or user plane (U-plane) latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device may be exposed to the outside through a hole configured through a housing to allow an internal configuration to perform a designated function. However, there may be a situation where the electronic device is exposed to moisture while being carried. Accordingly, moisture may enter the inside of the electronic device through the hole configured through the housing. For example, moisture may be introduced into the inner space where a speaker and/or microphone are placed, and a port (e.g., a connection terminal) for connecting to an external device may be a component directly exposed to moisture.

In case that an electronic device is operated while there is moisture in the inner space of the electronic device, the electronic device may be damaged (e.g., circuit damage or corrosion) or malfunction. Therefore, in order to prevent or reduce damage caused by using an electronic device while moisture has been introduced, it is necessary to perform an operation to identify whether moisture has been introduced into the inner space of the electronic device and whether the introduced moisture has been discharged or removed.

An embodiment disclosed herein may provide an electronic device, an operating method thereof, and a storage medium for performing an operation according to moisture detection so as to identify a location where moisture has been introduced into and efficiently discharge or remove the moisture.

In an embodiment, multiple speakers included in the electronic device may be used to identify a location where moisture has been introduced into. The electronic device may identify at least one speaker into which moisture has been introduced among the multiple speakers. The electronic device may control the identified at least one speaker to perform a moisture discharge function.

Accordingly, according to an embodiment, a user may identify a location where moisture has been introduced into to the electronic device through a notification of moisture introduction, thereby preventing or reducing damage to the electronic device due to use of the electronic device in a state where moisture has been introduced. In addition, according to an embodiment, by controlling to perform a moisture discharge function through at least one identified speaker, moisture in the speaker where the moisture has been introduced into or around the speaker may be efficiently and quickly evaporated or discharged.

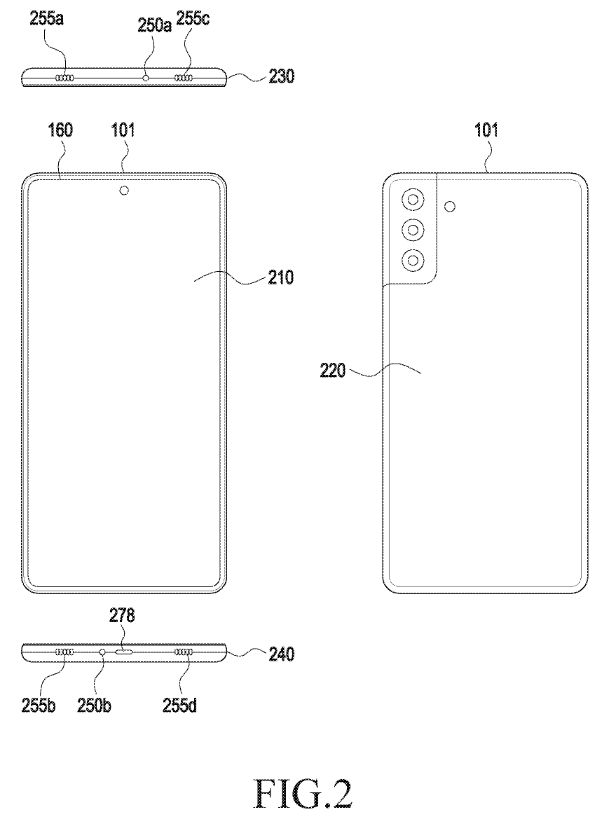

FIG. 2 is a diagram illustrating an example of an electronic device of a first type according to an embodiment of the disclosure.

Referring to FIG. 2, the electronic device 101 (e.g., the electronic device 101 in FIG. 1) according to an embodiment may be configured so that a display module 160 is disposed on a first surface (e.g., a front surface) 210 of a housing to allow a display panel to be exposed. For example, a surface on which the display is disposed (or through which the display module 160 is exposed to the outside of the electronic device 101) may be defined as a front surface of the electronic device 101. An opposite surface to the front surface may be defined as a second surface (e.g., a rear surface) 220 of the electronic device 101. The surface surrounding a space between the front surface and the rear surface may be defined as a lateral surface of the electronic device 101.

According to an embodiment, the electronic device 101 may include speakers 255a, 255b, 255c, and 255d on each of a third surface (e.g., an upper lateral surface) 230 or a fourth surface (e.g., a lower lateral surface) 240 of the housing. According to an embodiment, the electronic device 101 may include at least one microphone 250a or 250b. According to an embodiment, the electronic device 101 may include a connection terminal 278 (e.g., the connection terminal 178 in FIG. 1). As shown in FIG. 2, the speakers 255a, 255b, 255c, and 255d may be disposed on the third surface (e.g., the upper lateral surface) 230 or the fourth side (e.g., the lower lateral surface) 240 of the housing of the electronic device 201. For example, the speakers 255a, 255b, 255c, and 255d may be disposed adjacent to at least one microphone 250a or 250b.

According to an embodiment, at least one speaker 255a, 255b, 255c, or 255d may be disposed on a lateral surface in the embodiment shown in FIG. 2, but is not limited thereto, and at least one speaker 255a, 255b, 255c, or 255d or a speaker not illustrated may be provided as another separate structure to be disposed as a combined or assembled structure or arranged on both edges of the or electronic device 101. In this way, at least one speaker 255a, 255b, 255c, or 255d may be designed to be included in the structure of the electronic device 101 depending on the appearance and the usage state.

FIG. 2 illustrates an example where two microphones and four speakers are placed at the upper end or the bottom end, respectively, but the positions or numbers of the microphones and speakers may not be limited thereto.

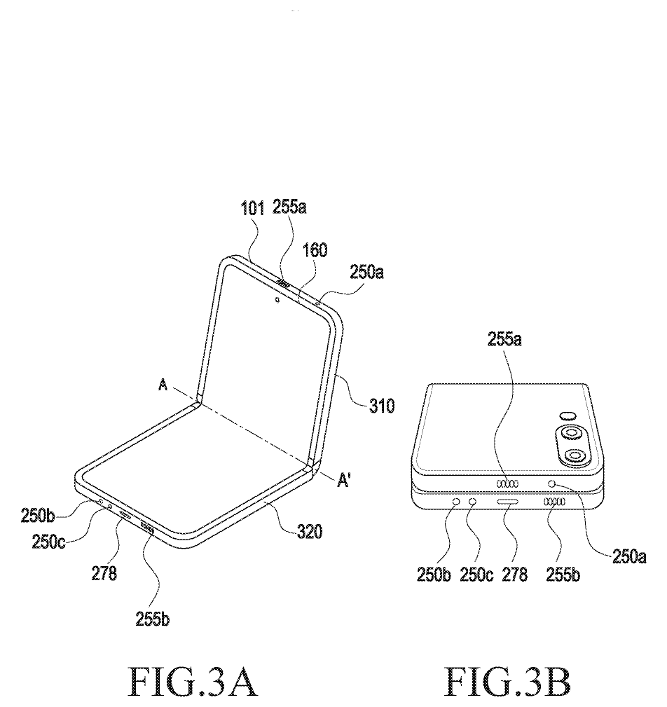

FIG. 3A is a diagram illustrating an example of an electronic device of a second type in a first state according to an embodiment of the disclosure, and FIG. 3B is a diagram illustrating an example of the electronic device of the second type in a second state according to an embodiment of the disclosure.

Referring to FIG. 3A, the electronic device 101 may have a partially unfolded state based on the folding axis (e.g., A-A'). The electronic device 101 may have a state in which a first housing structure 320 is in contact with a contact surface (e.g., a floor or a table) and a second housing structure 310 is erected based on the contact surface. As such, the electronic device 101 including the foldable display may be folded or bent with reference to one axis. For example, in case that the electronic device 101 is in the folded state as shown in FIG. 3B, a surface of a first area and a surface of a second area of the display 160 (or an inner display) may face each other while having a narrow angle (e.g., between 0 degrees and 10 degrees) therebetween. According to an embodiment, the display 160 may correspond to a flexible display having an area transformable to a flat surface or a curved surface.

FIGS. 3A and 3B illustrate an example in which two speakers 255a and 255b and three microphones 250a, 250b, and 250c are respectively arranged in the first housing structure 320 or the second housing structure 310, but the locations or numbers of the microphones and speakers may not be limited thereto.

Although FIGS. 2, 3A, and 3B illustrate a case where speakers and/or microphones are distributed in various locations of an electronic device having a fixed-structure display mounted therein, in the case of a structure having the slidable electronic device 101 or a rollable flexible display, the electronic device 101 may be designed such that the speakers and/or microphones are included in an expandable or contractible structure of the rollable flexible display depending on the appearance and the state of use. Accordingly, the locations at which the speakers and/or microphones are arranged or the number thereof may vary depending on the type of the electronic device 101.

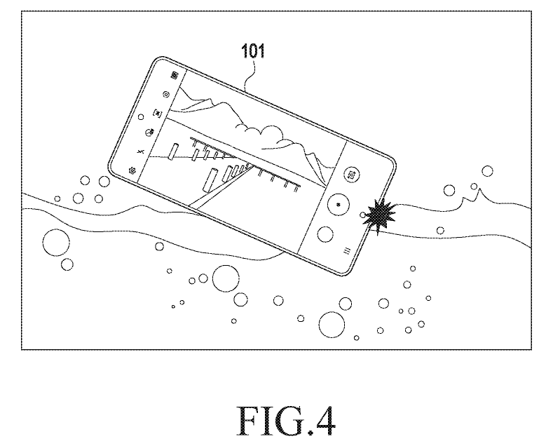

FIG. 4 is a diagram illustrating a moisture introduction situation according to an embodiment of the disclosure.

Referring to FIG. 4, after the user uses the electronic device 101 having a waterproof function around or in water, residual moisture may remain on a portion of the electronic device 101. For example, residual moisture may remain on a display, or moisture may remain around a charging terminal or a speaker. In case that the electronic device 101 is used while moisture remains on the electronic device 101, malfunction or failure of the electronic device 101 may be caused. For example, in case that moisture remains around a speaker, a sound signal to be output may be distorted, and failure of the speaker may be caused.

According to an embodiment, the electronic device 101 may detect a state of immersion or residual moisture and control the speaker to discharge or remove the moisture. Accordingly, moisture in the speaker or around the speaker may be quickly discharged or evaporated, thereby quickly restoring audio output performance and characteristics. In addition, if the user may quickly recognize a state of moisture introduction and identify the location of moisture introduction when using the electronic device 101, additional damage may be prevented or reduced by preventing any more moisture from introducing into the inner space of the corresponding location.

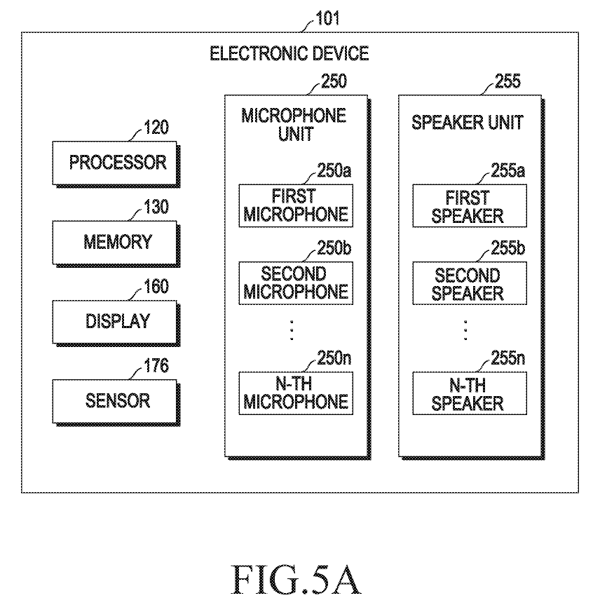

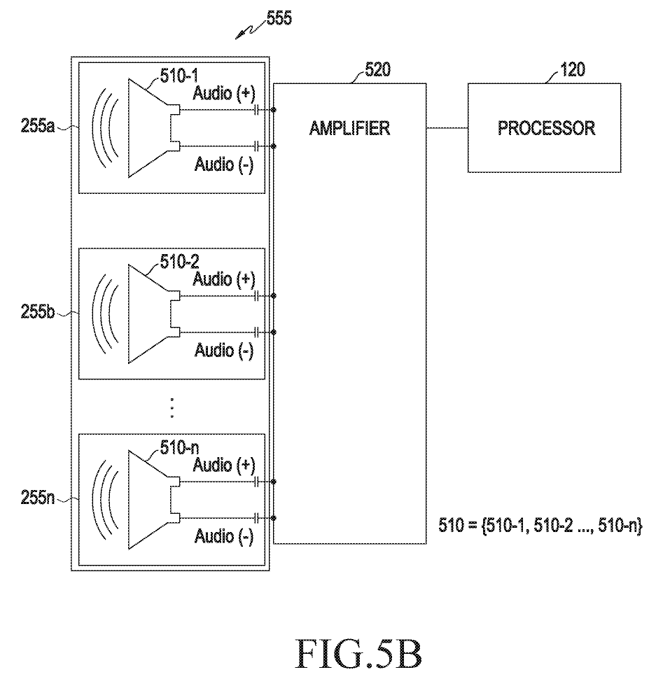

FIG. 5A is an internal block diagram of an electronic device according to an embodiment of the disclosure.

Referring to FIG. 5A, an electronic device 101 (e.g., the electronic device 101 in FIGS. 1 to 4) according to an embodiment may include at least one processor 120 (e.g., the processor 120 in FIG. 1), memory 130 (e.g., the memory 130 in FIG. 1), and/or multiple speakers (or speaker units) 255 (e.g., the sound output module 155 in FIG. 1). According to an embodiment, the electronic 101 may further include a display 160 (e.g., the display module 160 in FIG. 1), a microphone unit 250 (e.g., the input module 150 in FIG. 1), and/or at least one sensor 176 (e.g., the sensor module 176 in FIG. 1). The electronic device 101 in FIG. 5A may correspond to the electronic device 101 in FIG. 1. Here, not all components illustrated in FIG. 5A are essential components of the electronic device 101, and the electronic device 101 may be realized with more or fewer components than the components illustrated in FIG. 5A. In describing the electronic device 101 in FIG. 5A, a detailed description of a configuration similar to the embodiment of FIG. 1 or easily understandable through the embodiment of FIG. 1 may be omitted.

Referring to FIG. 5A, the processor 120 according to an embodiment may be electrically connected to the memory 130, the display 160, the sensor 176, the microphone unit 250, and the speaker unit 255.

According to an embodiment, the memory 130 may be electrically connected to the processor 120 and may store at least one application (e.g., the application 146 in FIG. 1). The memory 130 may store a control program for controlling the electronic device 101, a user interface (UI) related to an application provided by a manufacturer or downloaded from an external source, images for providing the UI, user information, documents, databases, or related data.

According to an embodiment, the display 160 may concurrently support input/output functions of data and detect a touch. The display 160 may be referred to as a touch screen. When realized in the form of a touch screen, the display 160 may display various pieces of information generated according to a user's touch operation. The display 160 may include the display module 160 described above with reference to FIG. 1.

According to an embodiment, the sensor 176 may output sensor information (or sensor values) including movement, tilt, tilting direction, and/or posture of the electronic device 101.

According to an embodiment, the speaker unit 255 may receive an electric signal from the processor 120, generate a sound, and output the sound to the outside. As shown in FIG. 5A, the speaker unit 255 may include multiple speakers (e.g., a first speaker 255a, a second speaker 255b, ..., an n-th speaker 255n).

The speaker unit 255 may also be referred to by terms such as speaker, speaker module, speaker device, or sound output device, and may be replaced with any component that generates a sound in the electronic device 101 in addition to the terms. As an example, the speaker unit 255 may include a receiver. For example, the speaker unit 255 may include a speaker used for general purposes such as multimedia reproduction or recording reproduction, and a receiver used for receiving an incoming call. According to an embodiment, the receiver may be realized separately from the speaker, or as a part thereof.

According to an embodiment, the microphone unit 250 may include multiple microphones 250a, 250b, ..., and 250n. For example, the microphone unit 250 or the electronic device 101 may detect the direction of a sound or detect an external sound through the multiple microphones 250a, 250b, ..., and 250n. The electronic device 101 or the processor 120 may suppress or remove noise based on the external sound detected by the microphone unit 250. For example, the processor 120 may attenuate a sound other than a multimedia sound or ringtone output by the speaker unit 255 based on the external sound detected by the microphone unit 250. In a voice call mode, at least one of the multiple microphones 250a, 250b, ..., and 250n may collect a user's voice. The electronic device 101 or the processor 120 may improve call quality in the voice call mode by using sounds collected through multiple microphones 250a, 250b, ..., and 250n to enhance the user's voice and suppress external sounds.

According to an embodiment, the processor 120 may identify a moisture introduction state by using a connection terminal (or connector) (e.g., the connection terminal 178 in FIG. 1 or the connection terminal 278 in FIGS. 2 and 3). For example, in case that the connection terminal follows the USB Type C standard, the connection terminal may include at least one configuration channel (CC) pin. An opening and a hole may be disposed on one surface of a housing of the electronic device 101 and the connection terminal may be arranged therein, and moisture may be introduced into the connection terminal due to this opening structure. According to an embodiment, the processor 120 may detect moisture based on at least one CC pin (e.g., CC1 or CC2) of the connection terminal. For example, the processor 120 may measure a voltage value or a resistance value corresponding to at least one CC pin of the connection terminal, and detect moisture introduction into the connection terminal based on the measured voltage value and/or resistance value.

The processor 120 may identify an initiation event based on detection of moisture introduction into the connection terminal. Accordingly, in case that moisture has been introduced into the connection terminal, the processor 120 may initiate an operation to detect whether moisture has been introduced or exists in the inner space (e.g., speaker) of the electronic device 101.

According to an embodiment, the initiation event for detecting whether moisture has been introduced or is present in the inner space of the electronic device 101 may include, for example, detection of moisture introduced into the connection terminal and execution of a designated function, but there is no limitation on the type of the initiation event. For example, in case that a designated function for outputting a sound included in content to the outside through a speaker is executed, an operation for detecting whether moisture has been introduced may be initiated to prevent or reduce damage to the speaker. Accordingly, the types of designated functions that require a sound output through a speaker, such as video applications and alarm applications, may vary and may not be limited thereto. For example, a case where a sound output is required, such as operation sounds, warning sounds, and message reception sounds, may also correspond to the initiation event for detecting whether moisture has been introduced. For example, in case that a designated function that detects movement of a user and/or an electronic device 101, such as a health application or a fall detection service, is executed, an operation for detecting whether moisture has been introduced or exists in the inner space of the electronic device 101 may be initiated. The processor 120 may identify moisture introduction into at least one of the multiple speakers 255a, 255b, ..., and 255n by using the multiple speakers 255a, 255b, ..., and 255n according to an initiation event, such as detection of moisture introduction into the connection terminal or execution of the designated function.

According to an embodiment, in response to detecting of moisture introduction into the connection terminal, the processor (120) may output a notification indicating a moisture introduction condition. For example, the processor 120 may output a warning sound warning of a moisture introduction state or display a warning message through the display 160.

According to an embodiment, in order to identify whether moisture has been introduced, the processor 120 may identify sensing values of designated terminals of each of the multiple speakers 255a, 255b, ..., and 255n. The processor 120 may use the sensing values to identify a speaker having moisture entered among the multiple speakers 255a, 255b, ..., and 255n. For example, the sensing values of the designated terminals of each of the multiple speakers 255a, 255b, ..., and 255n may correspond to resistance values for the designated terminals of each of the multiple speakers 255a, 255b, ..., and 255n.

In order to specifically examine a method for identifying the sensing values of designated terminals of each of the multiple speakers 255a, 255b, ..., and 255n, reference may be made to FIG. 5B.

FIG. 5B is a block diagram of a periphery of a speaker according to an embodiment of the disclosure.

Referring to FIG. 5B, the processor 120 may control speakers 555 (e.g., the speaker unit 255 in FIG. 5A) through an amplifier 520. Here, the speakers 555 correspond to the speaker unit 255 in FIG. 5A, and it should be construed that the control of the speakers 555 in FIG. 5B is for each of at least one speaker 255a, 255b, ..., and 255n. For example, the processor 120 may control the speakers 555 by applying a signal to a coil unit (e.g., a voice coil) of the speakers 555 through the amplifier 520. The coil unit moves according to the applied signal, and a diaphragm of the speakers 555 may move by the movement of the coil unit. As such, the processor 120 may control the speakers 555 to output a sound signal (or sound).

Referring to FIG. 5B, the speakers 555 may include an output unit 510 and an audio terminal (+ terminal or - terminal). For example, at least one speaker 255a, 255b, ..., and/or 255n may include an output unit 510-1, 510-2, ..., and/or 510-n and an audio terminal (+ terminal or - terminal), respectively.

According to an embodiment, the output unit 510 may generate a sound signal by an electrical signal. The output unit 510 may have the form of a coil wound around a magnet, and may change an electrical signal transmitted from an internal circuit of the electronic device 101 into a sound signal and output the sound signal.

According to an embodiment, the processor 120 may identify a sensing value for a designated terminal of the speakers 555 by applying a voltage (or current) of a designated frequency to the speakers 555. For example, the sensing value for the designated terminal of the speakers 555 may correspond to a value acquired by sensing (or measuring) a resistance (R) value between designated terminals of the speakers 555, for example, audio terminals (+ terminal and - terminal). In addition, the sensing value for the designated terminal of the speakers 555 may correspond to a value acquired by measuring an impedance of the speakers 555, and the type of the sensing value used to identify moisture introduction may not be limited thereto. For example, if the impedance of at least one speaker 255a, 255b, ..., and/or 255n is measured to be lower than a designated value, the processor 120 may determine (or decide) that moisture has been introduced into the interior of at least one speaker 255a, 255b, ..., and/or 255n.

In case that moisture enters the speakers 555 or a speaker duct thereof, a size of a sound signal output from the output unit 510 of the speakers 555 may decrease. For example, a resistance value for each designated terminal of each of the multiple speakers 255a, 255b, ..., and/or 255n may be sensed (or acquired), and the processor 120 may identify whether there is a resistance value that deviates from a threshold range among the sensed resistance values.

In case that a resistance value deviating a threshold range is identified, the processor 120 may identify at least one speaker, among the multiple speakers 255a, 255b, ..., and/or 255n, corresponding to the resistance value deviating from the threshold range as a speaker into which moisture has been introduced. For example, in the case of a speaker into which moisture has been introduced, a resistance value for a designated terminal may decrease or increase due to the introduction of moisture. Due to moisture introduction into the interior of at least one speaker 255a, 255b, ..., and/or 255n, a resistance value (e.g., the R value) of a diaphragm may deviate from a reference resistance value in a state where no moisture has been introduced, which may be detected by a designated terminal (e.g., the audio terminal (+ terminal or - terminal)).

Accordingly, when there is a resistance value that deviates by a predetermined value or more compared to a threshold range or a reference resistance value, the processor 120 may identify a speaker corresponding to the resistance value having the deviation. If the resistance values for each of the multiple speakers 255a, 255b, ..., and/or 255n are all deviate from the threshold range, the processor 120 may consider that the electronic device 101 is completely submerged. On the other hand, in case that at least one speaker corresponding to a resistance value that deviates from the threshold range among the multiple speakers 255a, 255b, ..., and/or 255n is identified, the processor 120 may identify the location of at least one identified speaker and display the location where moisture has been introduced through the display 160.

According to an embodiment, in order to identify whether moisture has been introduced, the processor 120 may use the multiple microphones (e.g., the multiple microphones 250a, 250b, ..., and/or 250n in FIG. 5A). The multiple microphones 250a, 250b, ..., and/or 250n and the multiple speakers 255a, 255b, ..., and/or 55n may be activated depending on an initiation event.

According to an embodiment, the processor 120 may output a reference sound through the multiple speakers 255a, 255b, ..., and/or 255n. The reference sound may include a start sound provided when the designated function is executed or a sound in a non-audible frequency band. For example, the sound in the non-audible frequency band may include a specific frequency band configured as a sound that is not perceptible to a user, for example, a sound above the audible frequency band or in an extremely low frequency range (e.g., a pilot tone). According to an embodiment, there may be multiple reference sounds for independent identification of the multiple microphones 250a, 250b, ..., and/or 250n.

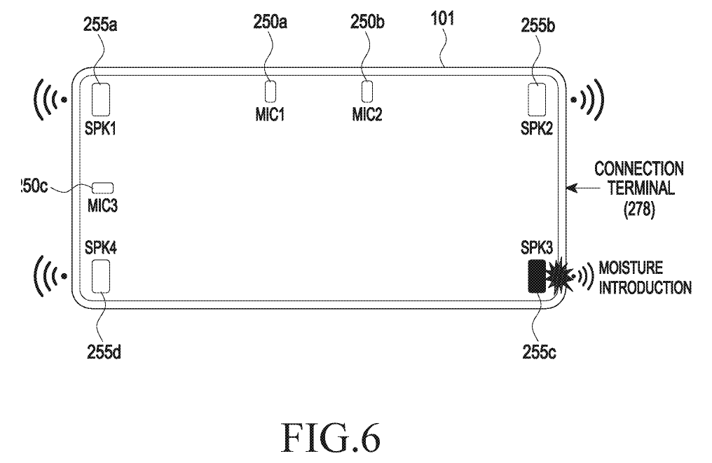

To examine the case more specifically, reference may be made to FIG. 6.

FIG. 6 is a diagram illustrating an example of an electronic device for detecting moisture introduction according to an embodiment of the disclosure. For example, considering a location between the microphone and the speaker, the electronic device 101 may be configured to output a first reference sound (e.g., 19 kHz) through a speaker (e.g., 255a or 255d) arranged on a first lateral surface, and to output a second reference sound (e.g., 20 kHz) through a speaker (e.g., 255b or 255c) arranged on a second lateral surface. For example, even if different reference sounds are output, the reference sounds may be determined such that sizes of sound signals of the different reference sounds input to the multiple microphones 250a, 250b, and 250c fall within a predetermined range.

Referring to FIG. 6, the processor 120 may acquire a sound signal corresponding to a reference sound input to activated multiple microphones 250a, 250b, and 250c. For example, the processor 120 may analyze the acquired sound signal and, based on an analysis result, identify a speaker having moisture entered among the multiple speakers 255a, 255b, 255c, and 255d.

FIG. 6 illustrates a case where the multiple speakers 255a, 255b, 255c, and 255d are respectively arranged at different locations of the electronic device 101 and the reference sound is output through the multiple speakers 255a, 255b, 255c, and 255d. If moisture has been introduced into a third speaker 255c, an output size of a reference sound output through the third speaker 255c may be smaller than output sizes of reference sounds from the other speakers 255a, 255b, and 255d. Accordingly, the processor 120 may identify that moisture has been introduced into the third speaker 255c based on a result of analyzing the size of the sound signal corresponding to the reference sound input to the multiple microphones 250a, 250b, and 250c. In addition, the processor 120 knows that the speaker into which moisture has been introduced is the third speaker 255c, and thus may also specify a location where the third speaker 255c is disposed. Accordingly, the processor 120 may output information that guides a tilting direction of the electronic device 101 so that moisture that has been introduced into the third speaker 255c may be discharged. In addition, the processor 120 may control the third speaker 255c to perform a moisture discharge function.

In the embodiments above, it has been illustrated that in order to identify whether moisture has been introduced, the processor 120 uses sensing values of multiple speakers 255a, 255b, 255c, and 255d or uses multiple microphones 250a, 250b, and 250c as an example, but, based on at least one of a comparison result of the acquired sound signal or the resistance values for the designated terminals of each of the multiple speakers, it is possible to identify whether moisture has been introduced into at least one of the multiple speakers.

According to an embodiment, the processor 120 may identify a tilting direction of the electronic device 101 by using the sensor 176. For example, the processor 120 may detect whether the electronic device 101 is tilted in the tilting direction for discharging moisture that has been introduced into the third speaker 255c. In response to detecting of the tilting of the electronic device 101, the processor 120 may control at least one speaker to perform the moisture discharge function.

As an example of the moisture discharge function, the processor 120 may control the third speaker 255c to output a signal of a designated frequency range therethrough. Heat may be generated due to the output of the signal of the designated frequency range, and moisture around the third speaker 255c may be evaporated or discharged by the generated heat.

As an embodiment of the moisture discharge function, heat may be generated due to sound output in a non-audible frequency band, and moisture around the third speaker 255c may be evaporated or discharged by the generated heat.

According to an embodiment, the processor 120 may output a reference sound for moisture discharge through at least one speaker into which moisture has been introduced. The processor 120 may vibrate a diaphragm inside at least one speaker into which moisture has been introduced by a sound in a non-audible band. By controlling the vibrating of the diaphragm inside the at least one speaker, heat may be generated, and moisture around the at least one speaker may be evaporated or discharged by the generated heat.

Meanwhile, examples of the moisture discharge function through at least one speaker into which moisture has been introduced are not limited thereto. For example, by controlling the movement of the diaphragm of at least one speaker into which moisture has been introduced, moisture may be discharged to the outside, and various moisture discharge methods may be possible.

The processor 120 according to an embodiment may display information about the moisture introduction condition on the display 160 while identifying the moisture introduction condition. For example, the processor 120 may display an object indicating a moisture introduction location on at least a portion of the display 160. The processor 120 may display an object (e.g., a graphic element, a function, or an indicator) indicating a speaker having moisture introduced.

According to an embodiment, an electronic device (101) may include multiple speakers (255), at least one processor (120), and memory (130) operatively connected to the multiple speakers and the at least one processor. According to an embodiment, the memory may store instructions which, when executed by the at least one processor, cause the electronic device to identify introduction of moisture into at least one speaker from among the multiple speakers by using the multiple speakers in response to executing of a designated function. According to an embodiment, the instructions may be configured to cause the electronic device to output information for guiding a tilting direction of the electronic device to discharge moisture that has been introduced into the at least one speaker. According to an embodiment, the instructions may be configured to cause the electronic device to enable the at least one speaker to perform a moisture discharge function.

According to an embodiment, the instructions may be configured to cause the electronic device to identify sensing values of designated terminals of each of the multiple speakers and to use the sensing values to identify moisture introduction into at least one of the multiple speakers.

According to an embodiment, the sensing values of the designated terminals of each of the multiple speakers may be resistance values for the designated terminals of each of the multiple speakers.

According to an embodiment, the electronic device may further include at least one microphone. According to an embodiment, the instructions may be configured to cause the electronic device to output a reference sound through the multiple speakers, acquire a sound signal corresponding to the reference sound through the at least one microphone, and identify moisture introduction into at least one speaker among the multiple speakers by using a comparison result of the acquired audio signal.

According to an embodiment, the reference sound may include a start sound provided when the designated function is executed or a sound in a non-audible frequency band.

According to an embodiment, the electronic device may further include a display 160. According to an embodiment, the instructions may be configured to cause the electronic device to display, through the display, information for guiding a tilting direction of the electronic device to discharge moisture that has been introduced into the at least one speaker.

According to an embodiment, the instructions may be configured to cause the electronic device to identify, by using resistance values for designated terminals of each of the multiple speakers, whether there is a resistance value deviating from a threshold range, and to identify at least one speaker corresponding to the resistance value deviating from the threshold range as a speaker having moisture introduced.

According to an embodiment, the instructions may be configured to cause the electronic device to identify moisture introduction into at least one of the multiple speakers based on at least one of a comparison result of the acquired sound signal or a resistance value for the designated terminals of each of the multiple speakers.

According to an embodiment, the electronic device may further include at least one sensor 176. According to one embodiment, the instructions may be configured to cause the electronic device to detect a tilt of the electronic device in a tilting direction of the electronic device by using the at least one sensor, and in response to detecting of the tilt of the electronic device, cause the at least one speaker to perform a moisture discharge function.

According to an embodiment, the instructions may be configured to cause the electronic device to perform the moisture discharge function by outputting a signal in a designated frequency range through the at least one speaker.

According to an embodiment, the electronic device may further include a connection terminal including at least one configuration channel (CC) pin. According to an embodiment, the instructions may be configured to cause the electronic device to detect moisture introduction into the connection terminal, and in response to detecting of the moisture introduction into the connection terminal, identify the moisture introduction into at least one speaker among the multiple speakers by using the multiple speakers.

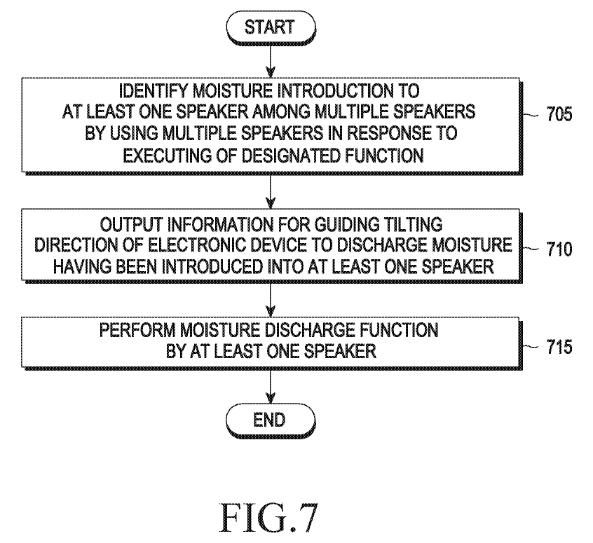

FIG. 7 is a flowchart of operations of an electronic device for performing an operation according to moisture detection according to an embodiment of the disclosure.

Referring to FIG. 7, an operating method may include operation 705 to operation 715. Each operation of the operating method in FIG. 7 may be performed by an electronic device (e.g., the electronic device 101 in FIGS. 1 to 4 and 5A) and at least one processor (e.g., the processor 120 in FIG. 1 or the processor 120 in FIGS. 5A and 5B) of the electronic device. In an embodiment, at least one of operations 705 to 715 may be omitted, the order of some operations may be changed, another operation may be added, and at least two operations may be performed in parallel.

In operation 705, the electronic device 101 may identify moisture introduction into at least one of multiple speakers by using the multiple speakers in response to executing of a designated function.

According to an embodiment, the electronic device 101 may identify sensing values of designated terminals of each of the multiple speakers. The electronic device 101 may identify moisture introduction into at least one of the multiple speakers by using the sensing values.

According to an embodiment, the sensing values of the designated terminals of each of the multiple speakers may be resistance values for the designated terminals of each of the multiple speakers.

According to an embodiment, the electronic device 101 may identify whether there is a resistance value deviating from a threshold range by using a resistance value for the designated terminals of each of the multiple speakers. The electronic device 101 may identify at least one speaker corresponding to the resistance value deviating from the threshold range as a speaker into which moisture has been introduced.

According to an embodiment, the electronic device 101 may output a reference sound through the multiple speakers. The electronic device 101 may acquire a sound signal corresponding to the reference sound through at least one microphone. The electronic device 101 may identify moisture introduction into at least one speaker among the multiple speakers by using a comparison result of the acquired sound signal.

According to an embodiment, the reference sound may include a start sound provided when the designated function is executed or a sound in a non-audible frequency band.

According to an embodiment, the electronic device 101 may identify moisture introduction into at least one of the multiple speakers based on at least one of the comparison result of the acquired sound signal or the sensing value for the designated terminals of each of the multiple speakers.

In operation 710, the electronic device 101 may control to output information guiding the tilting direction of the electronic device to discharge moisture that has been introduced into the at least one speaker. According to an embodiment, the electronic device 101 may display, through the display, information guiding the tilting direction of the electronic device to discharge moisture that has been introduced into the at least one speaker.

In operation 715, the electronic device 101 may control the at least one speaker to perform a moisture discharge function.

According to an embodiment, the electronic device 101 may detect tilting of the electronic device in the tilting direction of the electronic device by using at least one sensor. The electronic device 101 may control the at least one speaker to perform the moisture discharge function in response to detecting of the tilting of the electronic device.

According to an embodiment, the electronic device 101 may perform the moisture discharge function by outputting a signal in a designated frequency range through the at least one speaker.

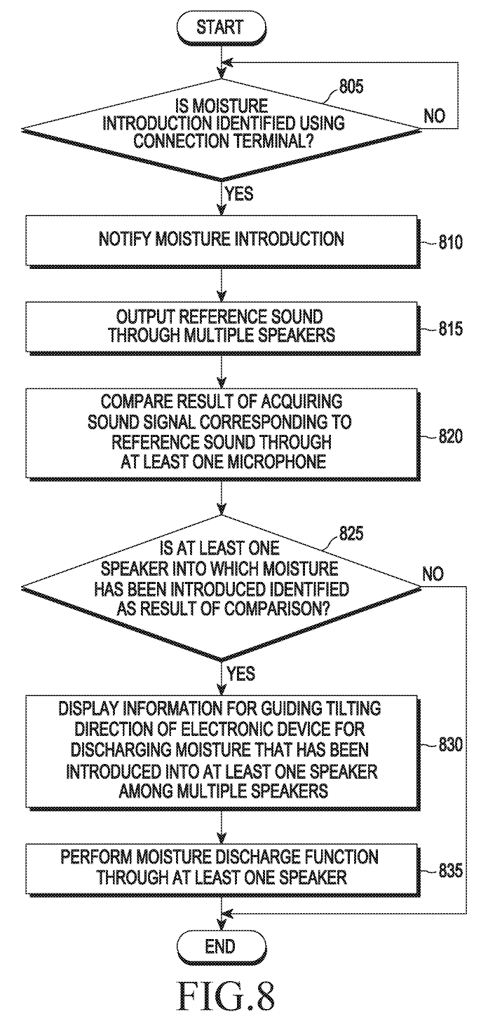

FIG. 8 is a flowchart of operations in an electronic device according to moisture detection using a connection terminal and a reference sound according to an embodiment of the disclosure.

Referring to FIG. 8, an operating method may include operation 805 to operation 835. Each operation of the operating method in FIG. 8 may be performed by an electronic device (e.g., the electronic device 101 in FIGS. 1 to 4 and 5A) and at least one processor (e.g., the processor 120 in FIG. 1 or the processor 120 in FIGS. 5A and 5B) of the electronic device. In an embodiment, at least one of operations 805 to 835 may be omitted, the order of some operations may be changed, another operation may be added, and at least two operations may be performed in parallel.

In operation 805, the electronic device 101 may identify moisture introduction by using a connection terminal (e.g., the connection terminal 278 in FIGS. 2 and 3). The electronic device 101 may identify an initiation event based on detection of moisture introduction into the connection terminal. In case that moisture has been introduced into the connection terminal, the electronic device 101 may initiate an operation to detect whether moisture has been introduced or exists in an inner space (e.g., a speaker) of the electronic device 101.

In operation 810, the electronic device 101 may perform an operation to notify of moisture introduction in response to identifying of moisture introduction.

In operation 815, the electronic device 101 may output a reference sound through the multiple speakers.

In operation 820, the electronic device 101 may compare a result of acquiring a sound signal corresponding to the reference sound through at least one microphone.

In operation 825, the electronic device 101 may determine whether at least one speaker into which moisture has been introduced is identified as a result of comparing the acquired sound signal. In case that the speaker into which moisture has been introduced is identified, in operation 830, the electronic device 101 may display information guiding the tilting direction of the electronic device to discharge moisture that has been introduced into the at least one speaker among the multiple speakers.

In operation 835, the electronic device 101 may perform the moisture discharge function through the at least one speaker.

According to an embodiment, the electronic device 101 may identify whether moisture that has been introduced into the at least one speaker has been discharged or removed while performing the moisture discharge function through the at least one speaker. The operation for identifying a moisture discharge state may be performed periodically or at a designated number of times. In case that the moisture discharge is completed, the electronic device 101 may display a notification message notifying the completion of the moisture discharge or removal so that the user may use the electronic device 101 again.

According to an embodiment, the electronic device 101 may identify whether moisture that has been introduced into the at least one speaker has been discharged or removed, and in case that the moisture has not been discharged or removed within a threshold range, may repeatedly perform operations 815 to 835 described above.

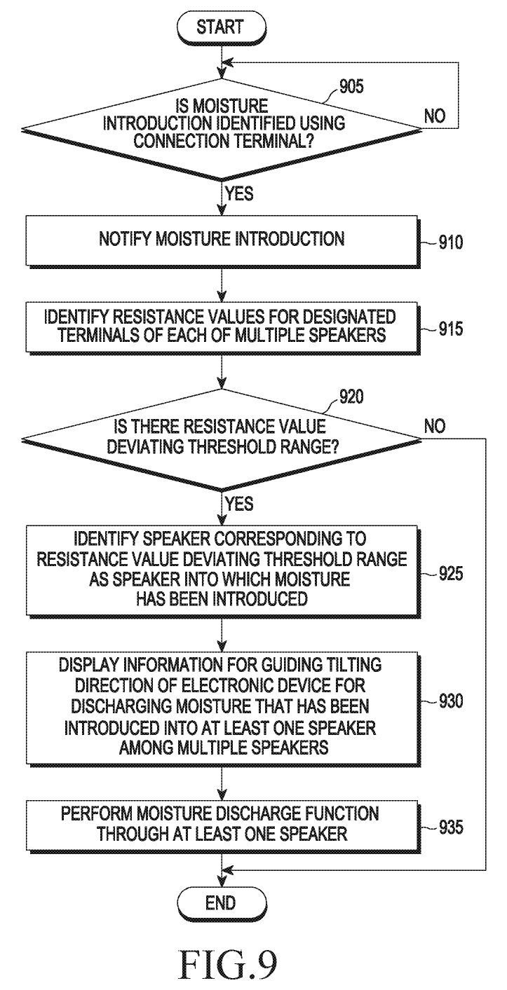

FIG. 9 is a flowchart of operations in an electronic device according to moisture detection using a connection terminal and a designated terminal of a speaker according to an embodiment of the disclosure.

Referring to FIG. 9, an operating method may include operation 905 to operation 935. Each operation of the operating method in FIG. 9 may be performed by an electronic device (e.g., the electronic device 101 in FIGS. 1 to 4 and 5A) and at least one processor (e.g., the processor 120 in FIG. 1 or the processor 120 in FIGS. 5A and 5B) of the electronic device. In an embodiment, at least one of operations 905 to 935 may be omitted, the order of some operations may be changed, another operation may be added, and at least two operations may be performed in parallel.

In operation 905, the electronic device 101 may identify moisture introduction by using a connection terminal. The electronic device 101 may identify an initiation event based on detection of moisture introduction into the connection terminal. In case that moisture has been introduced into the connection terminal, the electronic device 101 may initiate an operation to detect whether moisture has been introduced or exists in an inner space (e.g., a speaker) of the electronic device 101. In operation 910, the electronic device 101 may notify of moisture introduction in response to identifying of moisture introduction.

In operation 915, the electronic device 101 may identify a resistance value for designated terminals of each of the multiple speakers. For example, the electronic device 101 may identify a resistance value of a coil part connected to a diaphragm of each of the multiple speakers.

In operation 920, the electronic device 101 may identify a resistance value deviating from a threshold range. In case that there is the resistance value deviating from the threshold range, in operation 925, the electronic device 101 may identify at least one speaker corresponding to the resistance value deviating from the threshold range as a speaker into which moisture has been introduced. On the other hand, if there is no resistance value deviating from the threshold range, since there is no moisture introduction through the speaker, a moisture discharge function through the speaker may not be performed.

Meanwhile, in response to identifying of the speaker into which moisture has been introduced, in operation 930, the electronic device 101 may display information guiding a tilting direction of the electronic device to discharge moisture that has been introduced into the at least one speaker among the multiple speakers.

In operation 935, the electronic device 101 may perform the moisture discharge function through the at least one speaker.

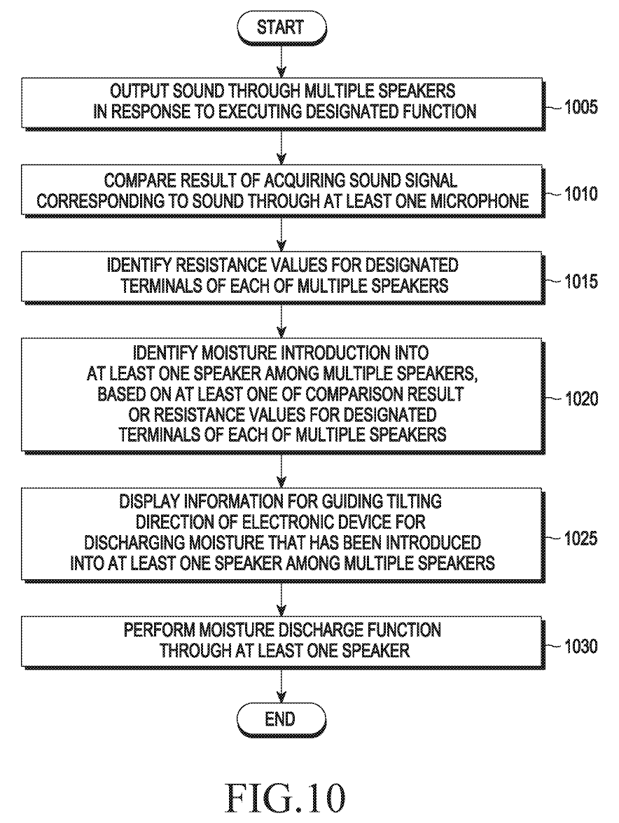

FIG. 10 is a flowchart of operations in an electronic device according to moisture detection using at least one of a reference sound or a designated terminal of a speaker according to an embodiment of the disclosure.

Referring to FIG. 10, an operating method may include operation 1005 to operation 1030. Each operation of the operating method in FIG. 10 may be performed by an electronic device (e.g., the electronic device 101 in FIGS. 1 to 4 and 5A) and at least one processor (e.g., the processor 120 in FIG. 1 or the processor 120 in FIGS. 5A and 5B) of the electronic device. In an embodiment, at least one of operations 1005 to 1030 may be omitted, the order of some operations may be changed, another operation may be added, and at least two operations may be performed in parallel.

For example, although operations 1005 to 1015 are illustrated as being performed sequentially in FIG. 10, operations 1005 and 1010 may be performed in parallel or simultaneously with operation 1015.

According to an embodiment, there may be a situation where even if moisture introduction into the connection terminal is not detected, moisture is introduced into an inner space (e.g., a speaker). Accordingly, in case that a designated function for outputting a sound included in content to the outside through a speaker is executed, the electronic device 101 may initiate an operation for detecting whether moisture has been introduced to prevent or reduce damage to the speaker. As such, the types of designated functions that require a sound output through a speaker, such as video applications and alarm applications, may vary and may not be limited thereto. For example, a case where a sound output is required, such as operation sounds, warning sounds, and message reception sounds, may also correspond to the initiation event for detecting whether moisture has been introduced.

In operation 1005, the electronic device 101 may output a sound through multiple speakers in response to executing of a designated function.

In operation 1010, the electronic device 101 may compare a result of acquiring a sound signal corresponding to the sound through at least one microphone.

In operation 1015, the electronic device 101 may identify a resistance value of a coil part connected to a diaphragm of each of multiple speakers.

In operation 1020, the electronic device 101 may identify moisture introduction into at least one of the multiple speakers based on at least one of the comparison result of the acquired sound signal or the resistance value for the designated terminals of each of the multiple speakers.

In operation 1025, the electronic device 101 may display information guiding a tilting direction of the electronic device to discharge moisture that has been introduced into the at least one speaker among the multiple speakers.

In operation 1030, the electronic device 101 may perform the moisture discharge function through the at least one speaker.

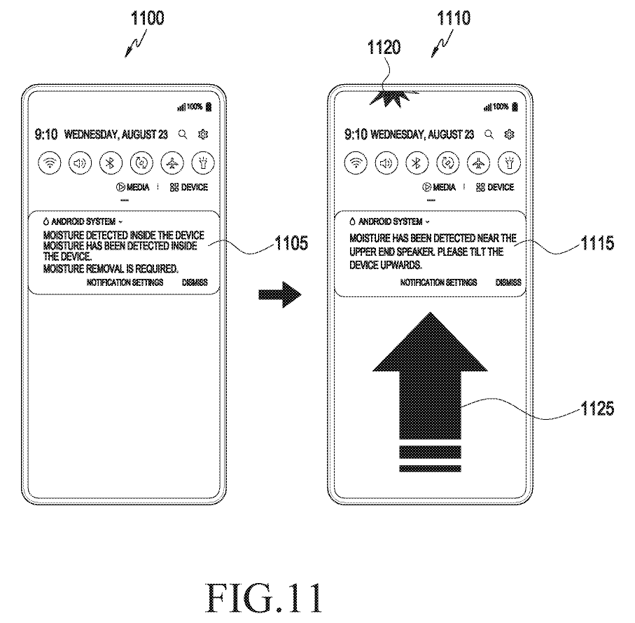

FIG. 11 is a diagram of a screen for guiding an operation for moisture removal according to an embodiment of the disclosure.

Referring to FIG. 11, the electronic device 101 may provide a configured notification in response to detecting of a state where moisture has been introduced into an inner space (e.g., at least one speaker and/or a connection terminal) of the electronic device 101. For example, as illustrated in drawing number 1100, the electronic device 101 may display a warning message 1105 to notify that the interior of the electronic device 101 may be damaged due to moisture introduction.

According to an embodiment, the electronic device 101 may display an object (e.g., a graphic element, a function, or an indicator) 1120 indicating a location where moisture has been introduced. For example, the object 1120 may be configured in various ways such that a user may immediately recognize a situation where moisture has been introduced into the electronic device 101 by displaying the object 1120 in a different color or using a blinking method. As such, by displaying the object 1120 indicating the location of a speaker where moisture has been introduced, the user may intuitively identify the location of the speaker where moisture has been introduced.

In an embodiment, the electronic device 101 may display guidance message 1115 guiding moisture discharge. For example, if it is determined that moisture has been introduced into at least one speaker disposed at the upper end of the electronic device 101 among the multiple speakers, the electronic device 101 may display a guidance message 1115 including information indicating the location where the moisture has been introduced. The guidance message 1115 may include information guiding a tilting direction of the electronic device 101 to discharge moisture that has been introduced into at least one speaker.

According to an embodiment, the information guiding the tilting direction of the electronic device to discharge moisture that has been introduced into the inner space (e.g., at least one speaker and/or connection terminal) of the electronic device 101 may be displayed using the object 1125. For example, by displaying the object 1125, such as an arrow, corresponding to the tilting direction, the user may intuitively know in which direction to tilt the electronic device 101 while the moisture discharge function is performed through the speaker corresponding to the location where moisture has been introduced, thereby preventing or reducing damage to the electronic device 101 due to use in a state where moisture has been introduced.

According to an embodiment, it is possible to identify whether moisture that has been introduced into the internal space has been discharged or removed while performing the moisture discharge function in the electronic device 101. The operation for identifying a moisture discharge state may be performed periodically or at a designated number of times. In case that the moisture discharge is completed, the electronic device 101 may display a notification message notifying the completion of the moisture discharge or removal so that the user may use the electronic device 101 again.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An embodiment may provide a non-transitory medium storing instructions, wherein the instruction, when executed by at least one processor 120 of an electronic device 101, may be configured to cause the electronic device to perform at least one operation, and the at least one operation may include an operation of identifying introduction of moisture into at least one speaker from among multiple speakers by using the multiple speakers 255 in response to executing of a designated function, an operation of outputting information guiding a tilting direction of the electronic device to discharge moisture that has been introduced into the at least one speaker, and an operation of causing the at least one speaker to perform a moisture discharge function.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
multiple speakers;
memory, comprising one or more storage media, storing instructions; and
one or more processors communicatively coupled to the multiple speakers and the memory,
wherein the instructions, when executed by the one or more processors individually or collectively, cause the electronic device to:
in response to execution of a designated function, identify moisture introduction into at least one speaker among the multiple speakers by using the multiple speakers,
output information for guiding a tilting direction of the electronic device to discharge the moisture introduced into the at least one speaker, and
cause the at least one speaker to perform a moisture discharge function.

2. The electronic device of claim 1, wherein the instructions, when executed by the one or more processors individually or collectively, further cause the electronic device to:
identify sensing values of designated terminals of each of the multiple speakers; and
identify moisture introduction into at least one speaker among the multiple speakers by using the sensing values.

3. The electronic device of claim 2, wherein the sensing values of the designated terminals of each of the multiple speakers correspond to resistance values for the designated terminals of each of the multiple speakers.

4. The electronic device of claim 2, further comprising:
at least one microphone,
wherein the instructions, when executed by the one or more processors individually or collectively, further cause the electronic device to:
output a reference sound through the multiple speakers,
acquire a sound signal corresponding to the reference sound through the at least one microphone, and
identify moisture introduction into at least one speaker among the multiple speakers by using a comparison result of the acquired sound signal, and
wherein the reference sound comprises a start sound provided when the designated function is executed or a sound in a non-audible frequency band.

5. The electronic device of claim 2, wherein the instructions, when executed by the one or more processors individually or collectively, further cause the electronic device to:
identify whether there is a resistance value out of a threshold range by using resistance values for the designated terminals of each of the multiple speakers, and
identify at least one speaker corresponding to the resistance value out of the threshold range as a speaker into which moisture has been introduced.

6. The electronic device of claim 2, further comprising:
a display,
wherein the instructions, when executed by the one or more processors individually or collectively, further cause the electronic device to display, through the display, information for guiding a tilting direction of the electronic device to discharge the moisture introduced into the at least one speaker.

7. The electronic device of claim 2, wherein the instructions, when executed by the one or more processors individually or collectively, further cause the electronic device to cause the electronic device to identify moisture introduction into at least one speaker among the multiple speakers, based on at least one of a comparison result of an acquired sound signal or resistance values for the designated terminals of each of the multiple speakers.

8. The electronic device of claim 1, further comprising:
at least one sensor,
wherein the instructions, when executed by the one or more processors individually or collectively, further cause the electronic device to:
detect tilting of the electronic device in the tilting direction of the electronic device by using the at least one sensor, and
in response to detection of the tilting of the electronic device, cause the at least one speaker to perform the moisture discharge function.

9. The electronic device of claim 1, wherein the instructions, when executed by the one or more processors individually or collectively, further cause the electronic device to perform the moisture discharge function by outputting a signal in a designated frequency range through the at least one speaker.

10. The electronic device of claim 1, further comprising:
a connection terminal comprising at least one configuration channel (CC) pin,
wherein the instructions, when executed by the one or more processors individually or collectively, further cause the electronic device to:
detect moisture introduction into the connection terminal, and
in response to detection of the moisture introduction into the connection terminal, identify moisture introduction into at least one speaker among the multiple speakers by using the multiple speakers.

11. A method performed by an electronic device for performing an operation according to detection of moisture introduction in the electronic device, the method comprising:
in response to execution of a designated function, identifying, by the electronic device, moisture introduction into at least one speaker among multiple speakers by using the multiple speakers;
outputting, by the electronic device, information for guiding a tilting direction of the electronic device to discharge moisture introduced into the at least one speaker; and
causing, by the electronic device, the at least one speaker to perform a moisture discharge function.

12. The method of claim 11, wherein the identifying of moisture introduction into at least one speaker among the multiple speakers comprises:
identifying sensing values of designated terminals of each of the multiple speakers; and
identifying moisture introduction into at least one speaker among the multiple speakers by using the sensing values.

13. The method of claim 12, wherein the sensing values of the designated terminals of each of the multiple speakers correspond to resistance values for the designated terminals of each of the multiple speakers.

14. The method of claim 12,
wherein the identifying of moisture introduction into at least one speaker among the multiple speakers comprises:
outputting a reference sound through the multiple speakers,
acquiring a sound signal corresponding to the reference sound through at least one microphone, and
identifying moisture introduction into at least one speaker among the multiple speakers by using a comparison result of the acquired sound signal, and
wherein the reference sound comprises a start sound provided when the designated function is executed or a sound in a non-audible frequency band.

15. The method of claim 12, further comprising:
identifying whether there is a resistance value out of a threshold range by using resistance values for the designated terminals of each of the multiple speakers; and
identifying at least one speaker corresponding to the resistance value out of the threshold range as a speaker into which moisture has been introduced.

16. The method of claim 11, further comprising:
displaying, through a display of the electronic device, information for guiding a tilting direction of the electronic device to discharge the moisture introduced into the at least one speaker.

17. The method of claim 11, wherein the identifying of moisture introduction into at least one speaker among the multiple speakers comprises identifying moisture introduction into at least one speaker among the multiple speakers, based on at least one of a comparison result of an acquired sound signal or sensing values for designated terminals of each of the multiple speakers.

18. The method of claim 11, further comprising:
detecting tilting of the electronic device in the tilting direction of the electronic device by using at least one sensor of the electronic device; and
in response to detecting the tilting of the electronic device, causing the at least one speaker to perform the moisture discharge function.

19. One or more non-transitory computer-readable storage media storing one or more computer programs including computer-executable instructions that, when executed by one or more processors of an electronic device individually or collectively, cause the electronic device to perform operations, the operations comprising:
in response to execution of a designated function, identifying, by the electronic device, moisture introduction into at least one speaker among multiple speakers by using the multiple speakers;
outputting, by the electronic device, information for guiding a tilting direction of the electronic device to discharge moisture that has been introduced into the at least one speaker; and
causing, by the electronic device, the at least one speaker to perform a moisture discharge function.

20. The one or more non-transitory computer-readable storage media of claim 19, the operations further comprising:
identifying sensing values of designated terminals of each of the multiple speakers; and
identifying moisture introduction into at least one speaker among the multiple speakers by using the sensing values.
